(19) United States
(12) Patent Application Publication
(10) Pub. No.: US 2021/0064245 A1
(43) Pub. Date: Mar. 4, 2021

(54) VIRTUAL TAPE BACKSPACE FILE PERFORMANCE ENHANCEMENT

(71) Applicant: EMC Corporation, Hopkinton, MA (US)

(72) Inventors: Larry W. McCloskey, Billerica, MA (US); Karyn M. Kelley, Peabody, MA (US)

(21) Appl. No.: 14/754,254

(22) Filed: Jun. 29, 2015

(51) Int. Cl. G06F 3/06; G06F 12/10

(52) U.S. Cl. CPC G06F 3/0611; G06F 12/10; G06F 3/0619; G06F 3/0644; G06F 3/0659; G06F 3/0664; G06F 2212/70; G06F 2212/1024; G06F 2212/1032; G06F 2212/152; G06F 2212/202; G06F 2212/213; G06F 2212/657; G06F 3/0682

(57) ABSTRACT

In one example, a method for repositioning a virtual tape includes receiving a tape backspace-file (BSF) command, determining a current position of a virtual tape, and accessing a map to identify, in the virtual tape, a highest tapemark below the current position of the virtual tape. The virtual tape can then be repositioned to the highest tapemark below the current position of the virtual tape.

### FIELD OF THE INVENTION

Embodiments of the present invention generally concern data backup and restoration. More particularly, at least some embodiments of the invention relate to systems, hardware, computer-readable media, and methods directed to processes for accessing data at particular locations in a backup, such as a virtual tape backup for example.

### BACKGROUND

Entities often generate and use data that is important in some way to their operations. This data can include, for example, business data, financial data, and personnel data. If this data were lost or compromised, the entity may realize significant adverse financial and other consequences. Accordingly, many entities have chosen to back up some or all of their data so that in the event of a natural disaster, unauthorized access, or other events, the entity can recover any data that was compromised or lost, and then restore that data to one or more locations, machines, and/or environments.

While data backup is a valuable and important function, the ever increasing volume of data that is generated presents significant problems. In particular, many companies today find their backup and recovery process strained as data growth in enterprise IT environment continues to accelerate at exponential rates, while data-protection solutions have struggled to keep pace.

Some of the problems that are experienced in such environments concern the need to access backed up data, whether for restoration or other purposes, that is stored in connection with a virtual tape system. For example, it is sometimes useful to be able to locate a particular block of data stored in a virtual tape system, such as when writing to, or reading from, the virtual tape system. However, while the location of the data block may be known, typical systems are not able to go directly to the desired location.

In particular, a tape backspace-file (BSF) command is sometimes used that instructs a tape drive to position the tape to a location of the closest preceding tapemark. However, this approach can be quite time consuming since it involves a sequential block-by-block search of the tape until the target tapemark is found. Depending upon variables such as the number of blocks in the tape, the length of the tape, and the position of the tape at the time the search is started, such a search could take several minutes, or longer.

In light of problems and shortcomings such as those noted above, it would be useful to be able to locate a particular tapemark using a non-sequential search of the tape. It would also be useful to be able to jump to a particular location on the tape. Finally, it would be useful to be able to jump in either direction, that is, forwards or backwards, to a particular location on the tape.

### BRIEF DESCRIPTION OF THE DRAWINGS

In order to describe the manner in which at least some aspects of this disclosure can be obtained, a more particular description will be rendered by reference to specific embodiments thereof which are illustrated in the appended drawings. Understanding that these drawings depict only example embodiments of the invention and are not therefore to be considered to be limiting of its scope, embodiments of the invention will be described and explained with additional specificity and detail through the use of the accompanying drawings, in which:

FIG. 1 is directed to aspects of an example operating environment for at least some embodiments;

FIG. 2 is directed to an example configuration of a computing system; and

FIG. 3 is directed to an example implementation of a map that may be employed with at least some embodiments;

FIG. 4 is a diagram of an example virtual tape and associated tapemarks and map; and

FIG. 5 is a workflow diagram disclosing aspects of an example BSF process.

### DETAILED DESCRIPTION OF SOME EXAMPLE EMBODIMENTS

Embodiments of the present invention generally concern systems, hardware, computer-readable media, and methods directed to processes for accessing data at particular locations in a backup, such as a virtual tape backup for example. It should be understood that the term ‘backup,’ as used herein, is intended to be broadly construed and is not limited to any particular type or form of backup. Thus, backup, as contemplated by this disclosure, embraces, but is not limited to, full backups, snapshots, incremental backups, de-duplicated backups, and any other circumstance or process where data that is desired to be protected is copied to one or more backup resources for protection. As well, the term ‘data’ is intended to be construed broadly and includes, by way of example and not limitation, data blocks, atomic data, emails, objects, files, directories, volumes, and any group of one or more of the foregoing.

In general, embodiments of the invention are able to locate a particular tapemark using a non-sequential search of a virtual tape, such as by jumping to a particular location on the virtual tape. As well, location of a tapemark can be performed by jumping either forwards or backwards to a particular location on the tape. In addition to performing relatively fast random data block locates, in either direction, embodiments of the invention also enable file skipping in either direction.

Functions such as these can be performed relatively quickly through the use of a map of the virtual tape. The map may be created when a file is written to the virtual tape, and a copy of the map can be located at the end of every virtual tape file. The map is relatively small and thus occupies little space on the virtual tape. Among other things, the map enables a search, such as a tape backspace-file (BSF) search for example, to be executed from a variety of different locations on the virtual tape. In general, the BSF command instructs the tape drive to reposition the tape directly in front of the preceding tapemark that is closest to the current position of the tape.

Positioning of the tape by the tape drive can be accomplished, for example, by way of indices included in the map. The map for a particular virtual tape includes an index for each of a plurality of different tapemarks. The indexes are reference points that are used to guide the positioning of the tape. Thus, the indexes can be used to enable execution of a BSF from various locations including, for example, from a location between two tapemarks, from a location immediately following a tapemark, from a location at a tapemark, and from a location below, or prior to, all the other tapemarks in the tape. In this last example, the BSF would cause the tape drive to move the tape to the beginning of the tape.

Advantageously then, embodiments of the invention provide for relatively fast BSF operations by enabling a tape drive to move a tape backward to a particular location on a virtual tape, rather than having to perform a sequential search of the virtual tape to find a tapemark for a random data block or file. Moreover, embodiments of the invention also enable relatively fast file skipping in a forward direction on the virtual tape, such as by way of Forward Space File (FSF) operations.

A. Example Operating Environments

In general, embodiments of the invention may include and/or be implemented in an operating environment that includes virtual tape archival storage systems and devices. The virtual tape technology includes devices and systems appliances that mimic tape libraries for backing up systems to disk arrays. That is, the backup data is saved as though it were being stored on a tape, but the backup data is actually stored on a hard disk, for example, or other storage medium. The virtual tape approach can enable relatively faster disk-to-disk backups and data restoration in the period before the backup data is eventually archived on tape backup systems. Lower operating costs may also be realized by the use of virtual tape systems. In at least some instances, the virtual tape system is configured to decide whether data, which could be backup data, should be made available by way of a relatively fast medium such as disk cache for example, or should instead be written to tape.

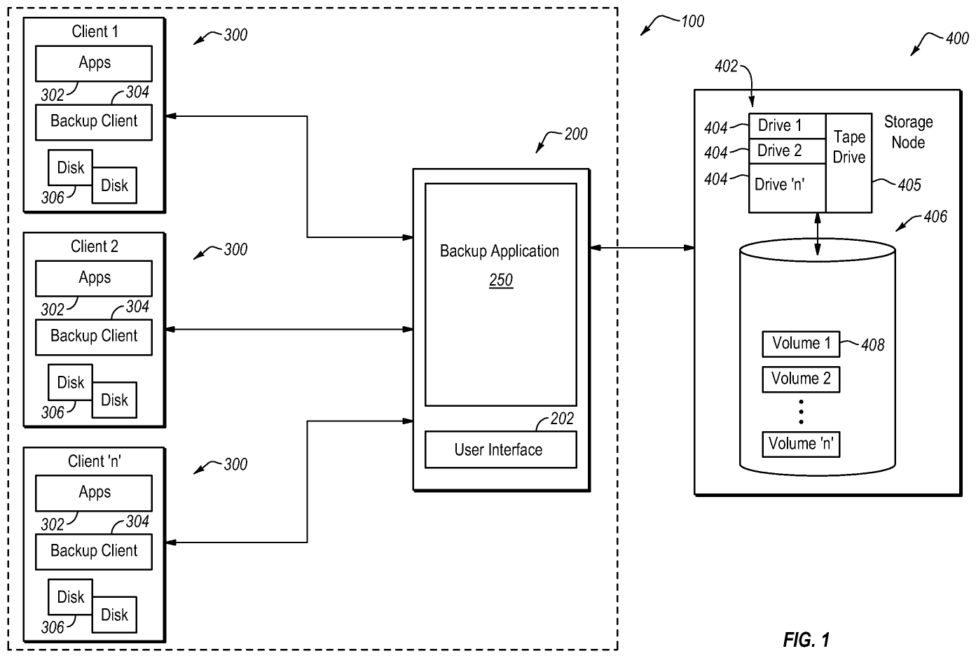

With the foregoing in mind, attention is directed now to FIG. 1 which discloses one example of an operating environment that may be suitable for one or more embodiments of the invention. In FIG. 1, the example operating environment is denoted at 100 and may be a network such as a local area network, a wide area network, or any other networked configuration. Moreover, the operating environment 100, or any group of one or more of its elements, may comprise, form an element of, or constitute, a cloud computing environment. The operating environment 100 may include various devices including servers and other computers that are interconnected. The operating environment 100 may employ a variety of communication media, such as hardwire, wireless, or some combination thereof. In some instances, some or all of the operating environment 100 may comprise an optical communication network.

As indicated in FIG. 1, the example operating environment 100 includes a backup server 200 configured for communication with one or more nodes, such as one or more clients 300, and a storage node 400. The storage node 400 can include an input/output (I/O) controller 402 that includes one or more tape volumes 404, which can be virtual tape volumes. The storage node 400 may also include a disk based storage system 406 that communicates with the I/O controller 402. When the backup server 200 writes data, such as by way of a tape drive 405, to one of the virtual tape volumes 404, the disk based storage system 406 stores that backup data as one or more tape volume images 408 that are included as part of a file system.

In general, backups of one or more of the clients 300 can be made by cooperation between the backup server 200 and the client 300, and the backups can then be stored by the backup server 200 at the storage node 400. Subsequently, one or more of the stored backups can be restored to one or more of the clients 300 and/or any other target(s). The backup server 200, clients 300, storage node 400 and/or target(s) may be physical machines, virtual machines (VM), or any other suitable type of device.

As indicated by the phantom box in FIG. 1, the backup server 200 and clients 300 can be integrated together into a single entity in some example embodiments. One example of such an entity is a mainframe computer with one or more backup applications. Accordingly, the scope of the invention is not limited to any particular arrangement of backup server 200 and clients 300.

One or more of the nodes, such as client 300, with which the backup server 200 communicates can take the form of a server. It is not required that the server be any particular type of server. One or more of the client(s) 300 include any of various applications 302 that generate data that is desired to be protected. As well, the client(s) 300 can each include a respective instance of a backup client 304 that generally operates in cooperation with the backup application 250 of the backup server 200 to create one or more backups that include data that is resident on storage media 306, such as disks for example, of the client 300.

B. Example Host Configuration

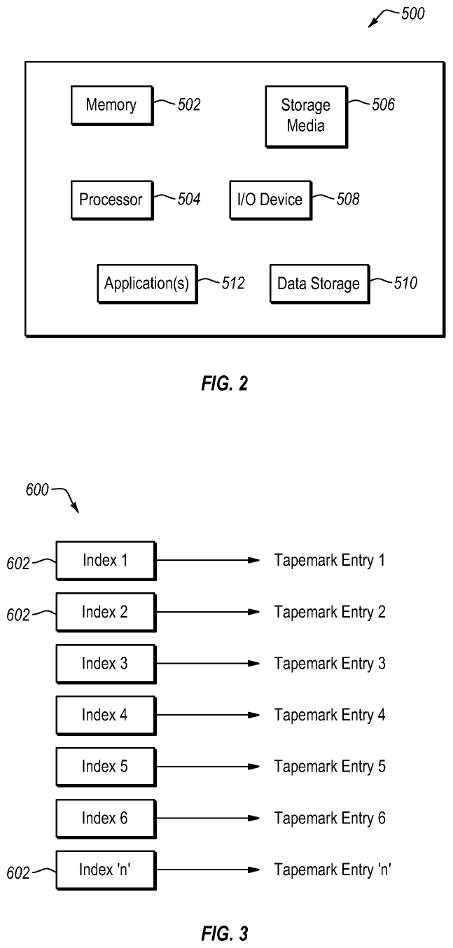

With reference briefly to FIG. 2, one or more of the backup server 200, clients 300, or storage node 400 can take the form of a physical computing device, one example of which is denoted at 500. In the example of FIG. 2, the computing device 500 includes a memory 502, one or more hardware processors 504, non-transitory storage media 506, I/O device 508, and data storage 510. As well, one or more applications 512 are provided that comprise executable instructions. Such executable instructions can take the form of one or more of a backup application, a backup client, or an application for controlling tape drive operations.

C. Example Maps, Tapemarks and Indexes

Turning now to FIG. 3, one example of a map that can be used in connection with various embodiments of the invention is denoted generally at 600. The map 600 can include one or more indexes 602, each of which corresponds to a particular tapemark or data block entry. For this particular tape, the map 600 includes six indexes 602, although a map could include more, or fewer, indexes. In general, an index can be associated with any particular location of interest in the virtual tape. Examples include a specific block of data, or the end of a group of blocks that constitute a file, such as a tapemark for example. In at least some embodiments, the tapemarks may each take the form of a data block having a particular length, and the tapemarks may each include, or define, start and/or finish positions that identify the location of a file on the virtual tape.

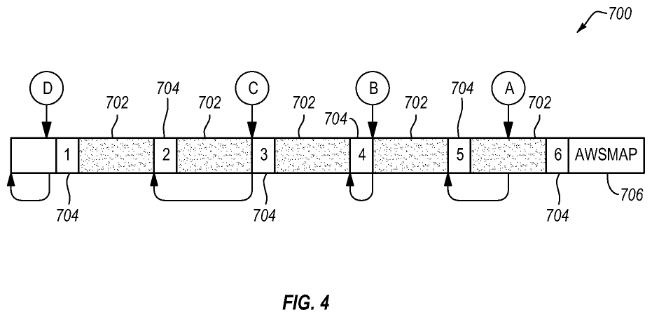

Directing attention now to FIG. 4, details are provided concerning an example virtual tape that includes tapemarks, data blocks, and a map. As indicated, the example virtual tape 700 includes one or more data blocks 702, each of which is associated with a corresponding tapemark 704. In particular, each of the tapemarks 704 is positioned at the end of a data block or group of data blocks 702. A map 706 follows the last tapemark 704. The map 706 can take the form indicated in FIG. 3, although that is not necessarily required. As suggested by FIG. 4, virtual tapes can be stored in an ‘AWS’ format and, as such, the map 706 may be referred to in one particular form as ‘AWSMAP.’ It should be understood however, that the scope of the invention is not limited to the ‘AWS’ format and, more generally, any other suitable format could alternatively be used.

In general, embodiments of the invention enable a BSF command to be executed from a variety of locations that, is locations on a virtual tape such as the virtual tape 700. Examples of such locations are denoted at ‘A,“B,”C,’ and ‘D’ in FIG. 4. The example location ‘A’ is between two tapemarks 704, namely, tapemark ‘5’ and tapemark ‘6.’ The example location ‘B’ is in a location that immediately follows a tapemark 704, namely, tapemark ‘4.’ The example location ‘C’ is in a location that immediately precedes a tapemark 704, namely, the tapemark ‘3.’ Finally, the example location ‘D’ is in a location below all of the tapemarks 704. As is apparent from these various example locations, and discussed in more detail below, a tape drive can be used to reposition a virtual tape 700 from a given location to another location through the use of the tapemarks. Thus, the new location for the tape can be identified, and the tape repositioned with the tape drive, without the need to perform a sequential search through the virtual tape 700 until the desired tapemark is found. This process may thus be referred to herein as a non-sequential positioning process.

With continued reference to FIG. 4, some example BSF operations will be discussed in more detail. The first example BSF operation is executed from location ‘A,’ which is positioned between two tapemarks. In this example, the tape drive moves the virtual tape from location ‘A’ to the highest tapemark entry lower than location ‘A.’ In particular, a search is performed of the map 706, a determination made that tapemark ‘5’ is the highest tapemark entry lower than location ‘A,’ and the tape drive repositions the virtual tape as shown to the location that immediately precedes tapemark ‘5.’

A second example BSF operation is executed from location 13,' which is positioned immediately following the tapemark ‘4.’ In this example, the tape drive moves the virtual tape from location ‘B’ to the highest tapemark entry lower than location ‘B.’ In particular, a search is performed of the map 706, a determination made that tapemark ‘4’ is the highest tapemark entry lower than location ‘B,’ and the tape drive repositions the virtual tape as shown to the location that immediately precedes tapemark ‘4.’

In a third example, a BSF operation is executed from location ‘C,’ which is positioned immediately preceding the tapemark ‘3.’ In this example, the tape drive moves the virtual tape from location ‘C’ to the highest tapemark entry lower than location ‘C.’ In particular, a search is performed of the map 706, a determination made that tapemark ‘2’ is the highest tapemark entry lower than location ‘C,’ and the tape drive repositions the virtual tape as shown to the location that immediately precedes tapemark ‘2.’

In a final example, a BSF operation is executed from location ‘D,’ which is positioned below all of the tapemarks. In this example, the tape drive moves the virtual tape from location ‘D’ to the highest tapemark entry lower than location ‘D.’ In particular, a search is performed of the map 706, a determination made that the beginning of the virtual tape is the highest tapemark entry lower than location ‘D,’ and the tape drive repositions the virtual tape as shown to the beginning of the virtual tape.

It will be appreciated from the foregoing that a sequence of multiple BSF operations can be performed. For example, after the virtual tape is repositioned from location ‘A’ to a location immediately preceding tapemark ‘5,’ the virtual tape could next be repositioned from that location to the highest tapemark lower than that location, which would be the location immediately preceding tapemark ‘4.’

It should be noted that in addition to BSF operations, embodiments of the invention can also be applied in various other cases as well. For example, at least some embodiments of the invention are well suited for use in fast file skipping in a forward direction on the virtual tape, such as FSF operations. Moreover, embodiments of the invention are also able to locate a specific tape block in the virtual tape by block number. This process can be performed both forward in the virtual tape, and backward in the virtual tape.

D. Aspects of Example BSF Methods

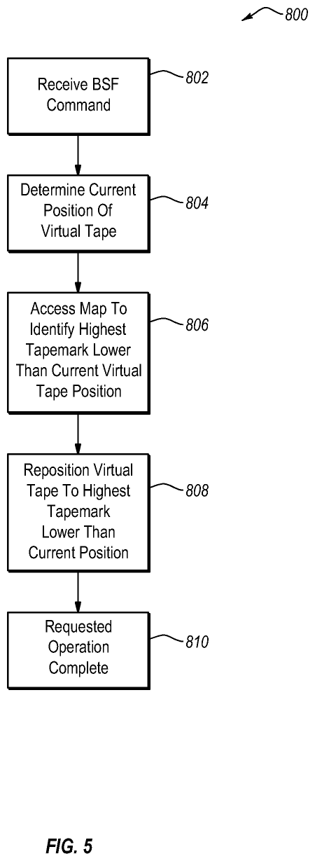

Directing attention now to FIG. 5, details are provided concerning aspects of methods relating to performance of a BSF process, one example of which is denoted at 800. In general, and as noted herein, methods and processes such as the method 800 can be used to control a tape drive to reposition a virtual tape to a desired location on the virtual tape. Thus, the method 800 may be useful in connection with read and write operations that are to be carried out by the tape drive with respect to the virtual tape.

Accordingly, the example method 800 can begin at 802 when a BSF command concerning a virtual tape is received, such as by a tape drive controller for example. The BSF command can be sent by an I/O controller and may be associated with a read or write command concerning the virtual tape. After the BSF command has been received 802, a determination 804 can be made as to the current position of the virtual tape with which the BSF command is concerned. This information can be used as a basis for repositioning of the virtual tape.

In particular, once the current position of the virtual tape has been determined 804, the map in the virtual tape is accessed 806. Because the map includes information about the tapemarks, such as their location on the virtual tape, the map information can be used to reposition the virtual tape. For example, and as shown in FIG. 5, the map can be used to identify the highest tapemark that is lower than the current virtual tape position. An example arrangement of tapemarks was discussed above in connection with FIG. 4.

After the current position of the virtual tape has been determined 804, and the location of the highest tapemark lower than the current position has been identified 806, the virtual tape can then be repositioned 808 by a tape drive or other device to that highest tapemark. Finally, a requested operation, such as a read or write operation for example, can be performed 810 after the virtual tape has been repositioned 808 according to the BSF command.

E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or target virtual machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for repositioning a virtual tape, comprising:
receiving a tape backspace-file (BSF) command instructing that a virtual tape be repositioned;
determining a current position of the virtual tape, wherein the virtual tape is stored in a tape volume on a disk-based storage node and wherein data blocks and tapemarks are stored on the disk-based storage node as though being stored on a tape and wherein each of the tapemarks is positioned at an end of a corresponding set of the data blocks in the virtual tape, wherein each tapemark is a data block that, identifies at least a start and a finish position of a set of data blocks on the virtual tape, wherein the tapemarks are stored with the sets of data blocks stored on the virtual tape such that sets of data blocks are separated by the tapemarks;
accessing a map to identify, in the virtual tape, a highest tapemark below the current position of the virtual tape, wherein the map includes a plurality of indexes and each of the indexes corresponds to a respective tapemark of the virtual tape and wherein the map follows a last tapemark, wherein each of the indexes identifies a location on the virtual tape such that the highest, tapemark relative to the current position is identified from the map;
when the current position of the virtual tape is either within a data block or adjacent to a data block, non-sequentially repositioning the virtual tape from the current position to a new position, wherein the new position is to a location that is immediately below the highest tapemark below the current position of the virtual tape, wherein repositioning of the virtual tape is performed based on one of the indexes in the map, and when no tapemark is below the current position of the virtual tape, the new position is a beginning of the virtual tape; and
repositioning, the virtual tape to a specific block in a set of data blocks adjacent the new position based on a block number of the specific data block.

2. The method as recited in claim 1, wherein the current position of the virtual tape is one of between two tapemarks of the virtual tape, immediately after a tapemark of the virtual tape, at a tapemark of the virtual tape, or below all tapemarks of the virtual tape.

3. The method as recited in claim 1, wherein the map is included in the virtual tape and is positioned above a highest tapemark of the virtual tape.

4. The method as recited in claim 1, wherein a tapemark of the virtual tape comprises a block of data.

5. The method as recited in claim 1, wherein a tapemark of the virtual tape immediately follows a grouping of one or more blocks of data.

6. The method as recited in claim 1, wherein the BSF command is associated with either a write command concerning the virtual tape or is associated with a read command concerning the virtual tape.

7. The method as recited in claim 1, wherein identification of the highest tapemark below the current position of the virtual tape comprises a non-sequential search process.

8. (canceled)

9. The method as recited in claim 1, further comprising performing a read process or a write process concerning the virtual tape after the virtual tape has been repositioned.

10. The method as recited in claim 1, wherein execution of the BSF command comprises the accessing of the map and the repositioning of the virtual tape.

11. (canceled)

12. The method as recited in claim 1, wherein the BSF command is executed at the current position of the virtual tape.

13. A non-transitory storage medium having stored therein computer-executable instructions which, when executed by one or more hardware processors, repositions a virtual tape by performing the operations:
receiving a tape backspace-file (BSF) command instructing that a virtual tape be repositioned;
determining a current position of the virtual tape, wherein the virtual tape is stored in a tape volume on a disk-based storage node and wherein data blocks and tapemarks are stored on the disk-based storage node as though being stored on a tape and wherein each of the tapemarks is positioned at an end of a corresponding set of the data blocks in the virtual tape, wherein each tapemark is a data block that identifies at least a start, and a finish position of a set, of data blocks on the virtual tape, wherein the tapemarks are stored with the sets of data blocks stored on the virtual tape such that sets of data blocks are separated by the tapemarks;
accessing a map to identify, in the virtual tape, a highest tapemark below the current position of the virtual tape, wherein the map includes a plurality of indexes and each of the indexes corresponds to a respective tapemark of the virtual tape and wherein the map follows a last tapemark, wherein each of the indexes identifies a location on the virtual tape such that the highest tapemark relative to the current position is identified from the map;
when the current position of the virtual tape is either within a data block or adjacent to a data block, non-sequentially repositioning the virtual tape from the current position to a new position, wherein the new position is to a location that is immediately below the highest tapemark below the current position of the virtual tape, wherein repositioning of the virtual tape is performed based on one of the indexes in the map, and when no tapemark is below the current position of the virtual tape, the new position is a beginning of the virtual tape; and
repositioning the virtual tape to a specific block in a set of data blocks adjacent the new position based on a block number of the specific data block.

14. The non-transitory storage medium as recited in claim 13, wherein the current position of the virtual tape is one of between two tapemarks of the virtual tape, immediately after a tapemark of the virtual tape, at a tapemark of the virtual tape, or below all tapemarks of the virtual tape.

15. The non-transitory storage medium as recited in claim 13, wherein the map is included in the virtual tape and is positioned above a highest tapemark of the virtual tape.

16. (canceled)

17. The non-transitory storage medium as recited in claim 13, further comprising performing a read process or a write process concerning the virtual tape after the virtual tape has been repositioned.

18. The non-transitory storage medium as recited in claim 13, wherein the BSF command is executed at the current position of the virtual tape.

19. The non-transitory storage medium as recited in claim 13, wherein the BSF command is associated with either a write command concerning the virtual tape, or is associated with a read command concerning the virtual tape.

20. A physical device, wherein the physical device comprises:
one or more hardware processors; and
the non-transitory storage medium as recited in claim 13.
